(19) United States
(12) Patent Application Publication
(10) Pub. No.: US 2021/0323530 A1
(43) Pub. Date: Oct. 21, 2021

(54) Device for Unfreezing Trailer Braking System

(71) Applicants: Calvin Macon, South Bend, IN (US); Jay Lenoir, Goshen, IN (US)

(72) Inventors: Calvin Macon, South Bend, IN (US); Jay Lenoir, Goshen, IN (US)

(21) Appl. No.: 17/229,947

(22) Filed: Apr. 14, 2021

Related U.S. Application Data
(60) Provisional application No. 63/010,542, filed on Apr. 15, 2020.

(51) Int. Cl. B60T 17/00; B60T 7/20; B60T 13/36

(52) U.S. Cl. CPC B60T 17/006; B60T 13/36; B60T 7/20

(57) ABSTRACT

The present invention relates to a device designed to quickly and efficiently unfreeze a frozen tractor trailer brake system. The device features a junction and T-valve assembly having a removable top plug, a quick connect fitting attached to both a first end of the junction and a tractor emergency brake line, and an outlet pipe attached to both a second end of the junction and the trailer glad hand. A de-icing solution may be introduced into an opening in the T-valve and forced through the trailer brake system by utilizing the air pressure from the tractor's emergency air brake, wherein the de-icing solution quickly and efficiently thaws the frozen brake system.

### CROSS-REFERENCE TO RELATED APPLICATION

The present application claims priority to, and the benefit of, U.S. Provisional Application No. 63/010,542, which was filed on Apr. 15, 2020 and is incorporated herein by reference in its entirety.

### FIELD OF THE INVENTION

The present invention relates generally to the field of tractor trailer braking systems. More specifically, the present invention relates to a device designed to unfreeze a frozen tractor trailer brake system in a very short duration of time. The device features a T-valve assembly having a removable top plug and a related hose that attaches to the brake system of the tractor. The device also integrates within the existing glad hand of the tractor trailer, and allows a user to pour a de-icing solution into the trailer brake system to quickly thaw a frozen brake system. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, air brake systems are typically used on trucks, buses, trailers and semi-trailers. In fact, the air brake is the preferred type of braking system because it couples multiple vehicle units together, ensures that each unit has braking capability, and allows each of said brakes to be controlled from the cab. Also, the air brake system allows for the incorporation of an emergency braking system that utilizes parts of the service brake and parking brake. However, in the winter and other cold conditions and climates, standard brakes can freeze up, thereby rendering the tractor trailer idle for a period of time until the brake system thaws out. The inability to use the tractor trailer to transport goods during such down time can result in significant amounts of time and money being lost by the owner and/or operator.

Accordingly, many drivers will try to unfreeze the frozen brake system using various traditional methods. For example, an individual may disconnect the emergency brake line from the trailer and pour de-icing solution into the emergency line in an effort the clear the blockage. However, this method of a de-icing a breaking system suffers from a number of inherent limitations and drawbacks. For example, in order for the poured de-icing solution to travel through the connector, the individual is oftentimes required to hold the emergency line in an upright position for a prolonged period of time, which is time-consuming, laborious and inefficient. Additionally, without any measurement device, it may be difficult to pour an appropriate amount of de-icing solution into the emergency connectors to clear the blockage. Further, it is difficult for the individual to both hold the emergency line in an upright position while pouring the de-icing solution into the line which may result in spillage, the solution contacting the individual's skin or clothing and damaging the same, and other hazardous conditions inasmuch as the de-icing solution is both hazardous and flammable. Moreover, even if the de-icing solution is successfully poured inside the emergency line, the emergency line must be re-connected to the trailer which is time-consuming, laborious and inefficient.

Alternatively, an individual may choose to contact a serviceperson to unfreeze the trailer brakes, who can use similar or other unfreezing methods or who may have specialized equipment for unfreezing the brake system. However, this involves the driver having to wait for the serviceperson to arrive at the location of the idle tractor trailer and then wait an additional period of time while the serviceperson unfreezes the brake system, which involves a significant amount of additional downtime and lost productivity. Further, the service charges associated with utilizing a remote service are usually high, thereby making such assistance both unaffordable and inefficient.

Therefore, there exists a long felt need in the art for a device that may be used to quickly and efficiently unfreeze a frozen tractor trailer braking system, without the need for outside serviceperson assistance, which can be both time-consuming and expensive. There is also a long felt need in the art for a device for unfreezing a braking system that does not result in significant downtime, and that enables the user to pour an appropriate amount of de-icing solution into the brake line without spilling the same onto the user, his or her clothes or the ground. Additionally, there is a long felt need in the art for a device for unfreezing a braking system that does not require the user to disassemble and then reassemble portions of the braking system, which can be time-consuming, laborious and inefficient, or to hold a disassembled emergency brake line in an upright position for a prolonged period of time. Finally, there is a long felt need in the art for a device for unfreezing a braking system that is relatively inexpensive to manufacture and install, and that is both safe and easy to use.

The subject matter disclosed and claimed herein, in one embodiment thereof, comprises a device for unfreezing a tractor trailer brake system that is comprised of an aluminum junction having an integrated T-valve, wherein the T-valve is substantially perpendicular to the junction and comprises a removable plug or cap that permits easy access to the brake line. The device further comprises a hose to connect the device to the emergency brake line, and an outlet pipe configured to connect to a glad hand of the trailer. To use the device, a user simply removes the removable plug or cap from the T-valve and pours a predetermined amount of a de-icer solution into the T-valve which is then passed to the frozen braking system of the trailer through the glad hand using the relatively high pressure in the emergency brake line. The junction and T-valve legs are substantially cylindrical in shape, and the removable plug may be fastened to the T-valve leg via a threaded connection or other secure means.

In this manner, the device for unfreezing a tractor trailer brake system of the present invention accomplishes all of the forgoing objectives, and provides a relatively safe, easy, convenient and cost-effective solution to unfreezing frozen trailer brakes. The device for unfreezing a tractor trailer brake system of the present invention is also user friendly inasmuch as it is less expensive than other alternatives, and does not require the user to spend considerable time and effort to manually disassemble and then reassemble the emergency brake line to unfreeze the trailer brakes. Further, the device for unfreezing a tractor trailer brake system enables the user to pour an appropriate amount of de-icing solution into the line without spilling the solution on the user, his or her clothes or the ground.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, is a device for unfreezing a trailer brake system comprised of an aluminum junction having a T-valve leg, a hose to connect the device to an emergency line, and an outlet pipe configured to connect to a glad hand of a trailer. The integrated T-valve leg is substantially perpendicular to the junction and has a removable plug to cover the opening of the T-valve when not in use. A de-icer solution may be poured into the T-valve leg after removing the removable plug, wherein the solution then passes through the braking system of the trailer using the high pressure received from the emergency line and thaws the blockage.

In a further embodiment of the present invention, a method for releasing a frozen trailer braking system is disclosed. The method comprises the steps of (a) providing an aluminum junction having two ends with an integrated T-valve, (b) connecting one end of the aluminum junction to an emergency brake line hose via an integrated hose, (c) connecting an output tube to the second end of the aluminum junction and to an existing glad hand of a trailer, (d) removing a cap or lid from the top of the T-valve, (e) pouring a quantity of de-icing solution into the T-valve, (f) reinstalling the removable plug over the T-valve opening to close the valve, and (g) starting the emergency brake line system of the tractor to push the de-icer solution into the braking system of the trailer to thaw the frozen brake line.

In yet a further embodiment of the present invention, a portable device for de-icing frozen trailer brakes when the trailer is connected to a truck or a tractor is disclosed. The device comprises an T-valve integrated to, and in fluid communication with, an aluminum junction, wherein the T-valve acts as a reservoir for a de-icing solution, a removable plug disposed atop of the T-valve, a hose to connect the device to an emergency brake line, and an output line to connect the device to a trailer glad hand, whereby the de-icing solution is passed through the frozen braking system of the trailer via the outlet pipe and the pressure from the tractor air braking system. In one embodiment, the T-valve of the aluminum junction is substantially cylindrical in shape, and can have diameter of approximately two inches and a length of approximately four inches. Accordingly, the combination T-valve and junction can store up to 10 ounces of the de-icing solution, which should be adequate in most instances to thaw the frozen line.

It should be appreciated that the device for unfreezing a trailer brake system of the present invention is capable of unfreezing a frozen brake system in a relatively short period of time and does not require the user to disassemble and then reassemble the emergency brake system to accomplish the same. The device easily attaches to the existing glad hand of a tractor trailer and uses the existing connection of the braking system. The device also significantly reduces the cost, time, effort and manual labor historically associated with releasing a frozen brake system, and improves overall operational efficiencies.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a device for unfreezing a trailer braking system of the present invention in accordance with the disclosed architecture;

FIG. 2 illustrates a perspective view of one potential embodiment of the connections of the device for unfreezing a trailer braking system of the present invention in accordance with the disclosed architecture, wherein the connection to the glad hand is clearly illustrated;

FIG. 3 illustrates a perspective view of one potential embodiment of the device for unfreezing a trailer braking system of the present invention in accordance with the disclosed architecture, wherein the connection between the device and the emergency line is disconnected;

FIG. 4 illustrates a perspective view of one potential embodiment of the device for unfreezing a trailer braking system of the present invention in accordance with the disclosed architecture, wherein the connection between the device and the emergency line is connected and a de-icer solution is being added to the device; and

FIG. 5 illustrates a flow diagram of one potential method of installing and using the device for unfreezing a trailer braking system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a device that may be used to quickly and efficiently unfreeze a frozen tractor trailer braking system without the need for outside assistance and the expense associated with the same. There is also a long felt need in the art for a device for unfreezing a braking system that does not result in significant downtime, and that enables the user to pour an appropriate amount of de-icing solution into the brake line without spilling the same onto the user, his or her clothes or the ground. Additionally, there is a long felt need in the art for a device for unfreezing a braking system that does not require the user to disassemble and then reassemble portions of the braking system, which can be time-consuming, laborious and inefficient, or to hold a disassembled emergency brake line in an upright position for a prolonged period of time. Finally, there is a long felt need in the art for a device for unfreezing a braking system that is relatively inexpensive to manufacture and install, and that is both safe and easy to use.

The present invention, in one exemplary embodiment, is a novel device for unfreezing a brake system on a trailer. The device comprises an aluminum junction having a first end, a second end, a continuous opening extending between the first and second ends and an integrated T-valve. The T-valve is substantially perpendicular to the junction and has an opening therein that is in fluid communication with the continuous opening. A removable plug or cap is used to cover the opening of the T-valve when the same is not in use. The device further comprises a hose that connect the first end of the junction to an emergency brake line on a tractor, and an outlet pipe that connects the second end of the junction to a glad hand on a trailer. In use, a de-icer solution is poured into the T-valve opening after removing the removable cap, and is jettisoned through the frozen trailer braking system via the relatively high pressure received from the emergency brake line.

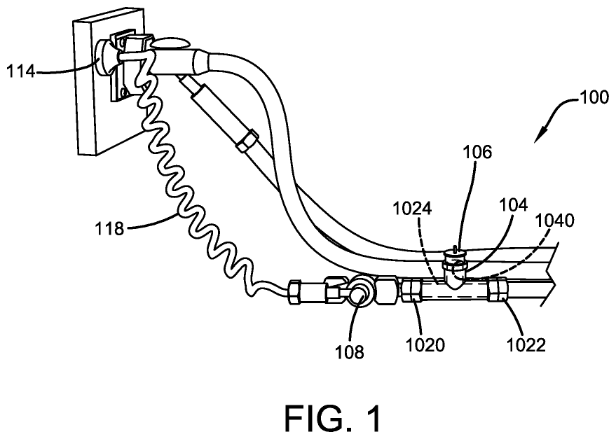

Referring initially to the drawings, FIG. 1 illustrates a perspective view of one potential embodiment of a device 100 for unfreezing a trailer braking system of the present invention in accordance with the disclosed architecture. The device 100 is comprised of a junction 102 having a first end 1020, a second end 1022, a continuous opening 1024 extending between the first end and second ends 1020, 1022 and a T-valve 104 having an opening 1040 therein. The opening 1040 in the T-valve may be selectively sealed or closed with a removable plug or cap 106 at its top via, for example, a threaded connection between the plug 106 and the T-valve 104. More specifically, the plug 106 may be removed from the T-valve 104 to pour a quantity of de-icer solution 404 into the opening 1040 as needed to unfreeze a brake system as described below, wherein the opening 1040 is in fluid communication with the continuous opening 1024. The junction 102 and T-valve 104 are preferably, but not required to be, integrally formed, and comprised of an aluminum or other suitable material and both are generally cylindrical in shape.

The first end 1020 of the junction 102 is connected to, and in fluid communication with, an emergency brake line 118 of a conventional brake system through a hose 108. Similarly, the second end 1022 of the junction 102 is connected to, and in fluid communication with, a glad hand 116 on a trailer brake system through an outlet pipe 112. As noted above, the removable plug 106 is fastened around the T-valve 104 through a threaded connection. The plug 106 provides an air tight seal to avoid the loss of air from the T-valve 104 during the standard operation of the braking system. The T-valve 104 may have a diameter of approximately two inches, and a depth of approximately four inches, as measured from its outermost portion to the junction 102. The diameter of the T-valve should be such that the de-icer solution 404 can be easily poured into the opening 1040 without spillage or coming into contact with the user's skin or clothes. As explained more fully below, the de-icer solution 404 is poured into the opening 1040 in the T-valve 104, and then passes through the continuous opening 1024 in the junction 102 and through the trailer brakes through the outlet pipe 112 with pressure from the emergency brake line 118. The emergency line 118 is connected to the tractor brake system via a connector 114, as best shown in FIGS. 1-3.

As also stated above, the junction 102 and the T-value 104 are preferably integrally formed as a single unit and comprised of aluminum. The junction 102 has a first end 1020 connected to the emergency line through the hose 108, and a second end 1022 connected to the outlet pipe 112. The emergency air system of the tractor provides the necessary pressure through the emergency brake line 118 to force the poured de-icer solution 404 from the opening 1040 in the T-valve 104 through the braking system of the trailer to thaw the same. More specifically, the relatively high pressure allows the de-icer solution 404 to unfreeze the trailer brakes in exponentially less time than alternative methods, thereby saving extensive time, effort and money.

Accordingly, a user such as a driver does not have to go underneath the trailer to unfreeze the brakes and/or manually disconnect and reconnect portions of the brake system to thaw a frozen brake system, both of which are time-consuming, dangerous and inefficient for the reasons stated above. Additionally, the device 100 is conveniently positioned between the tractor and the trailer where it is easily accessible to the user, and is in fluid communication with both of the emergency brake 118 line and the existing glad hands 116 of a tractor trailer. Further, the device 100 can remain connected to the emergency brake line 118 when the tractor engine is active, or the device 100 can be easily removed when the same is no longer needed. The system 100 of the present invention works well with both the braking systems of the tractor and the trailer.

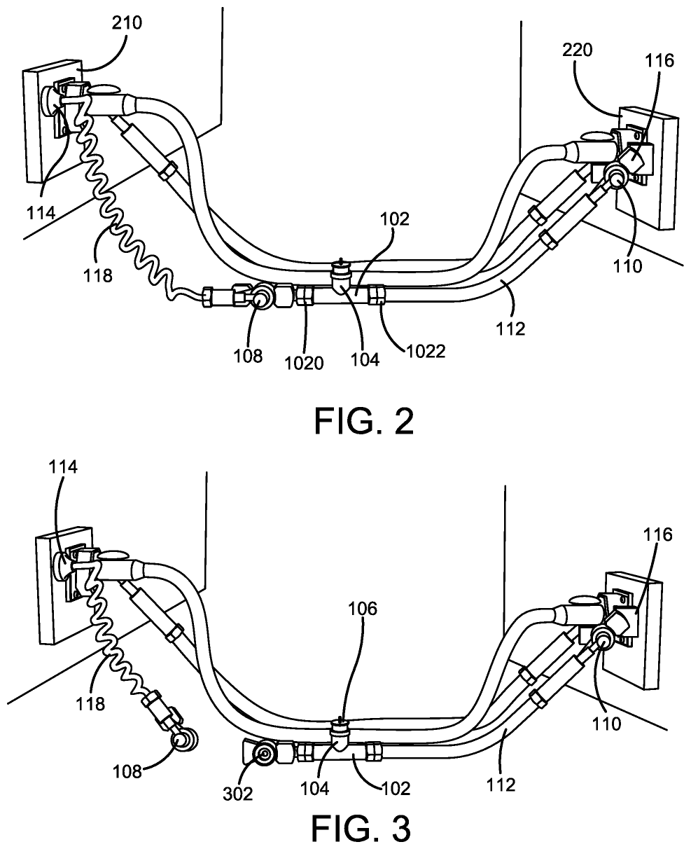

FIG. 2 illustrates a perspective view of one potential embodiment of the various connections of the device 100 for unfreezing a trailer braking system of the present invention in accordance with the disclosed architecture, wherein the connection to the glad hand 116 is clearly illustrated. As shown, the junction 102 having an integrated T-valve 104 with a removable cap 106 is connected to the tractor braking system 210 through an emergency brake line 118 via the connector 114 and a quick connect/disconnect hose or fitting 108. More specifically, one end of the quick connect/disconnect hose or fitting 108 is removably attached to the first end 1020 of the junction 102, and the second end of the fitting 108 is removably attached to the emergency brake line 118, as best shown in FIG. 2.

To connect to the trailer braking system 220, an outlet pipe 112 is removably attached to the second end 1022 of the junction 102 which is connected to the glad hand 116 via a second hose 110 of the trailer braking system 220. The pressure of the emergency air system through the emergency line 118 is used to transmit the de-icing solution 404 present within the opening 1040 in the T-valve 104 and the continuous opening 1024 in the junction 102 towards the braking system 220 of the trailer through the outlet pipe 112 and the second hose 110 where it is used to thaw the frozen braking system 220.

Because the junction 102 with the integrated T-valve 104 is in fluid communication with the existing glad hands 116 of a tractor trailer and pressurized by the air from the emergency brake line 118, a user is able to flush the de-icer solution 404 through the trailer brake system 220 to de-ice the brakes and/or other connections of the trailer. The brakes of the trailer are quickly released using the de-icing solution 404, and an operator/user may pour additional de-icing solution 404 into the system to serve as an antifreeze and prevent future freeze-ups in very cold conditions. Additionally, as stated earlier, the device 100 of the present invention can remain installed after unfreezing of the brake system, or can be uninstalled and the emergency brake line 118 can be directly connected to the trailer braking system. Nonetheless, in a preferred embodiment, the device 100 will remain installed even after unfreezing of the brake system, so that it is readily available when needed and to eliminate the need for repeated installation of the device 100 between the tractor and the trailer braking systems.

FIG. 3 illustrates a perspective view of one potential embodiment of the device 100 for unfreezing a trailer braking system of the present invention in accordance with the disclosed architecture, wherein the quick connect device 108 between the device 100 and the emergency brake line 118 is disconnected. More specifically, the quick connect hose/fitting 108 of the emergency line 118 may be attached to a compatible hose 302 of the junction 102 to complete the connection between the junction 102 and the emergency line 118, or can be connected directly thereto to eliminate the need for the hose 302. When present, the hoses 108, 302 are conveniently attached to one another other to facilitate a closed connection between the braking systems of the tractor and the trailer.

During use, the removable plug 106 covers the opening 1040 in the T-valve 104 so that the poured de-icing solution 404 is forced into the braking system of the trailer by the relatively high pressure from the emergency brake line 118. The device 100 of the present invention can be used as an emergency brake releaser in cold climates wherein the trailer braking system becomes frozen. Further, the outlet pipe 112 may or may not be integrally formed with the second end 1022 of the junction 102. Also, the hose 110 may be of similar construction to both the emergency line hose 108 and/or the junction hose 302, if present.

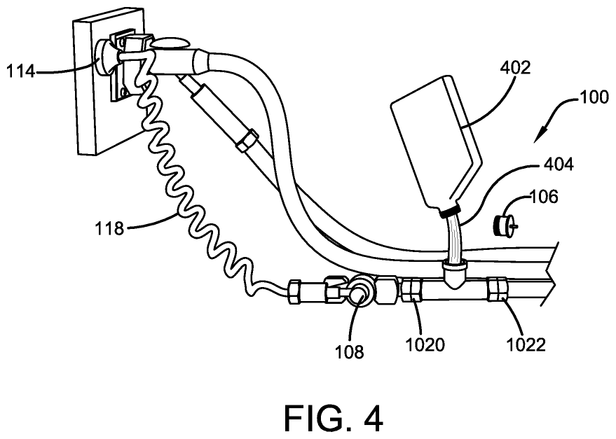

FIG. 4 illustrates a perspective view of one potential embodiment of the device 100 for unfreezing a trailer braking system of the present invention in accordance with the disclosed architecture, wherein the connection between the device 100 and the emergency brake line 108 is connected and a de-icer solution 404 is being added to the opening 1040 in the T-valve 104. More specifically, to quickly and efficiently unfreeze the trailer brake system, the user will confirm that the junction 102 is connected to the emergency line 118 forming a closed connection, and also that the outlet pipe 112 is connected to the glad hand 116 of the trailer. Once confirmed or appropriate corrective action has been taken, the plug 106 is removed from the T-valve 104 (e.g., by unscrewing the same) and a predetermined amount of the de-icer solution 404 is easily poured from a solution bottle 402 into the opening 1040 of the T-valve which is in fluid communication with the continuous opening 1024 in the junction 102.

Once the de-icing solution 404 has been added to the device 100, the cap 106 is again attached to the T-valve 104 to form an air tight connection (e.g., by threading the cap 106 to the threaded T-valve 104). Once the air tight connection is established, the emergency air brake system 210 of the tractor is initiated and a relatively high air pressure is transmitted through the emergency brake line 118 to the junction 102, which in turn forces the de-icer solution 404 through the trailer braking system 220 of the trailer via the outlet pipe 112, glad hand 116, etc. to thaw the frozen system.

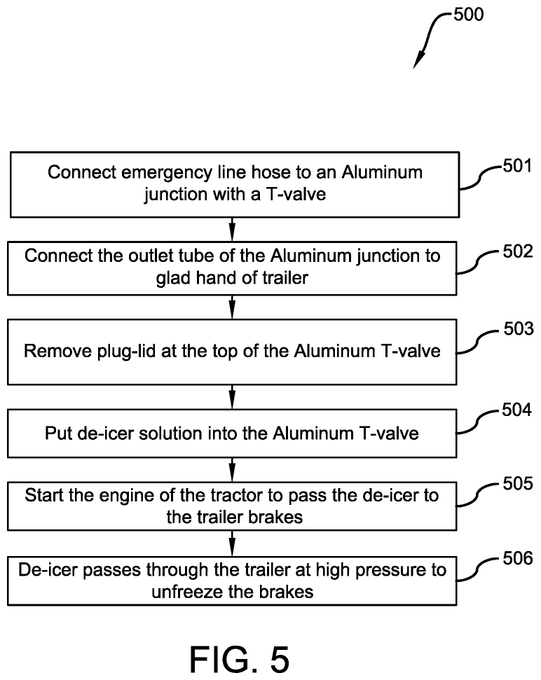

FIG. 5 illustrates a flow diagram of one potential method 500 of installing and using the device 100 for unfreezing a trailer braking system of the present invention in accordance with the disclosed architecture. More specifically, the device 100 is removably installed inline with the tractor's emergency air brake line 118 to form an air tight connection (i.e., with the cap 106 properly sealed to the T-valve 104) at Block 501. Next, at Block 502, the outlet pipe 112 of the device 112 is installed inline with the glad hand 116 of the trailer, and the cap 106 is removed from the top of the T-valve 104 at Block 503. Note that the tractor's emergency air brake system should not be engaged when the cap 106 is removed from the T-valve 104 to avoid the loss of pressurized air from the system.

At Block 504, an appropriate quantity of de-icing solution 404 (e.g., approximately 10 ounces) is poured into the opening 1040 of the T-valve 104, which is in fluid communication with the continuous opening 1024 of the junction 102. The cap 106 is then reattached to the T-valve 104 to again form an air tight seal therewith. At Block 505, the air engine of the tractor is started to energize and pressurize the tractor's emergency brake system, forcing the de-icing solution 404 through the outlet pipe 112, glad hand 116 and into the trailer brake system 220 to unfreeze or thaw the same at Block 506, typically in a matter of minutes.

It should be appreciated that the user can easily install the device 100 of the present invention inline with a tractor-trailer braking system and add the de-icing solution 440 with minimal effort. The device 100 does not require the user or operator to call for third party assistance, which can be both time-consuming and expensive. The device 100 also does not require the user or operator to go underneath the trailer to disconnect and reinstall portions of the brake system to thaw the same, or expose his or her skin, clothes or the environment to the deicing solution, which is both flammable and hazardous. Additionally, the device 100 of the present invention is relatively lightweight, portable and can be easily stored within a box in the tractor or trailer until needed.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “anti-freeze system”, “anti-freeze system for trailer brakes”, “trailer braking system”, “brake unfreezing system”, “trailer brake unfreezing system” and “unfreezing brake system” are interchangeable and refer to the device 100 for unfreezing a trailer braking system of the present invention.

Notwithstanding the forgoing, the device 100 for unfreezing a trailer braking system of the present invention and its various components can be of any suitable size and configuration as is known in the art without affecting the overall concept of the invention, provided that the same accomplish the above-stated objectives. One of ordinary skill in the art will appreciate that the size, configuration and material of the device 100 for unfreezing a trailer braking system as shown in the FIGS. are for illustrative purposes only, and that many other sizes and shapes of the device 100 for unfreezing a trailer braking system are well within the scope of the present disclosure. Although the dimensions of the device 100 for unfreezing a trailer braking system are important design parameters for user convenience, the device 100 for unfreezing a trailer braking system may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and configurations that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for unfreezing a braking system on a trailer, the device comprising:
a junction having a first end, a second end and a continuous opening therein;
a T-valve integrally formed with the junction, wherein the T-valve is substantially perpendicular to the junction and has an opening therein that is in fluid communication with the continuous opening;
a cap removably attached to the T-valve;
a hose attached to the first end of the junction; and
an outlet pipe attached to the second end of the junction.

2. The device of claim 1, wherein the hose is attached to an emergency brake line on a tractor.

3. The device of claim 2, wherein the outlet pipe is attached to a trailer glad hand.

4. The device of claim 3, wherein the T-valve is cylindrical in shape and has a diameter of approximately two inches.

5. The device of claim 4, wherein the T-valve and the junction are comprised of an aluminum.

6. The device of claim 5, wherein the attachment of the cap to the T-valve is a threaded connection.

7. The device of claim 6, wherein the first end the junction is removably attached to a tractor emergency brake line via a quick connect fitting.

8. The device of claim 7, wherein the outlet pipe is in fluid communication with a glad hand on the trailer.

9. The device of claim 8, wherein the device is pressurized when an air brake system on a tractor is activated and the cap is removably attached to the T-valve.

10. The device of claim 9 further comprising a compatible hose positioned between, and in fluid communication with, each of the first end of the junction and the quick connect fitting.

11. A method for releasing a frozen brake system on a trailer that is connected to a tractor, the method comprising the steps of:
providing a junction having a first end, a second end, a continuous opening extending between the first end and the second end, and an integrated T-valve with an opening therein that is covered by a removable cap;
connecting the first end to an emergency brake line on the tractor;
connecting the second end to a glad hand on the trailer;
removing the removable cap from the opening in the T-valve;
pouring a quantity of a de-icing solution into the opening in the T-valve, wherein the opening is in fluid communication with the continuous opening;
reinstalling the removable cap over the opening in the T-valve; and
starting the emergency line of the tractor to push the quantity of the de-icing solution into the frozen brake system.

12. The method of claim 11, wherein the starting of the emergency line of the tractor pressurizes the junction with a quantity of compressed air.

13. The method of claim 12, wherein the connecting of the first end to the emergency brake line on the tractor is accomplished with a quick connect fitting.

14. The method of claim 13, wherein the integrated T-valve is cylindrical in shape and has a diameter of approximately two inches.

15. The method of claim 14, wherein the integrated T-valve and the junction are comprised of an aluminum.

16. The method of claim 15, wherein the removable cap and the integrated T-valve form a threaded connection.

17. The method of claim 16 further comprising a compatible hose positioned between, and in fluid communication with, each of the first end of the junction and the quick connect fitting.

18. The method of claim 17 further comprising an outlet pipe positioned between, and in fluid communication with, each of the second end of the junction and the glad hand.

19. The method of claim 17 further comprising a hose positioned between, and in fluid communication with, each of the outlet pipe and the glad hand.

20. A device for unfreezing a braking system on a trailer, the device comprising:
a junction having a first end, a second end and a continuous opening therein;
a T-valve connected to the junction and having an opening therein that is in fluid communication with the continuous opening; and
a cap removably attached to an end of the T-valve opposite the junction, wherein the first end of the junction is in fluid communication with a pressurized air brake line and further wherein the second end of the junction is in fluid communication with the braking system on the trailer.
